(19) United States
(12) Patent Application Publication
(10) Pub. No.: US 2002/0081185 A1
(43) Pub. Date: Jun. 27, 2002

(54) Spring assist ramp

(76) Inventor: Arlyn Hedtke, Grove City, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/005,192

(22) Filed: Dec. 5, 2001

Related U.S. Application Data
(63) Continuation-in-part of application No. 09/474,845, filed on Dec. 30, 1999.
(60) Provisional application No. 60/119,683, filed on Feb. 11, 1999.

(51) Int. Cl. B60P 1/43

(52) U.S. Cl. 414/537

(57) ABSTRACT

A ramp for use with a flat bed trailer, the ramp pivotally coupled proximate an end margin of the trailer and being shiftable between a loading disposition and a transport disposition, the ramp includes a load support structure. A hinge mechanism is pivotally coupled to the load support structure and the trailer proximate the trailer end margin, the hinge mechanism biasing the load support structure toward an intermediate, neutral disposition. A first hinge pin is fixably coupled proximate the end margin of the trailer and shiftably coupled to the hinge mechanism, the first hinge pin allowing the ramp to be laterally shifted to a multiplicity of positions across the width of the trailer as desired. A hinge mechanism and a trailer are also included.

This application is a continuation-in-part of U.S. application Ser. No. 09/474,845 filed Dec. 30, 1999, which claims the benefit of U.S. Provisional Application No. 60/119,683 filed Feb. 11, 1999.

### BACKGROUND OF THE INVENTION

1. Field of the Invention

The present invention relates to heavy duty trailers, particularly trailers adapted for transporting industrial and agricultural vehicles. More particularly, the present invention relates to ramps for loading vehicles onto a trailer.

2. Background of the Invention

Heavy duty trailers, particularly trailers utilized for transporting industrial and agricultural vehicles, are known. The vehicles to be transported typically have significant weight, such as skid steers, back hoes, and agricultural tractors. The trailers for transporting such vehicles typically have massive frames and beds, the beds usually being made of two-inch planking. Additionally, ramps utilized for driving the vehicles onto the trailers are carried at the rear of the trailers. Typically, there are two ramps spaced apart an adjustable distance in order to accommodate the distance between the wheels of the various vehicles to be loaded onto the trailer. The ramps are typically hinged and rotate between a transport disposition, carried on the bed of the trailer, and a loading disposition in which the ramps provide a declining extension of the bed surface of the trailer, extending from the rear of the trailer to ground level.

Like the trailers themselves, the ramps must be designed to bear a substantial amount of weight during loading and unloading operations. Accordingly, each of the ramps may weigh between 100 and 150 pounds. Typically, the ramps are manually rotated through approximately 180 degrees of rotation between the transport disposition and the loading disposition. One or two human operators are needed when the full weight of the ramps must be lifted and rotated onto the trailer bed.

In order to minimize the potential for injury to the operators, it is desirable that a single operator be able to shift the ramps between the dispositions and that the operator bear no more than 50 to 60 pounds when shifting a ramp from one disposition to another.

### SUMMARY OF THE INVENTION

The present invention substantially meets the aforementioned needs of the industry. In the present invention, the ramps retain the necessary strength to bear the weight of a heavy vehicle being loaded onto the trailer or unloaded from the trailer. The ramp of the present invention is biased in an intermediary, neutral disposition. The amount of biasing of the ramp is increased as the ramp is rotated from the neutral disposition to either the loading or transporting disposition. When an operator raises the ramp from either the loading or transporting dispositions, the bias toward the neutral disposition acts to assist in this task, such that the operator bears only 50 to 60 pounds of the full weight of the ramp in order to lift the ramp from the loading or transporting disposition. When the ramp reaches the intermediate, neutral position, the ramp of the present invention is no longer biased. By applying a slight bias to the ramp when it is in the neutral position, the operator can continue to rotate the ramp toward the desired disposition. At this point, the weight of the ramp exceeds the force of the bias toward the neutral disposition and the ramp continues to the desired disposition. Springs are tensioned as the ramp continues to the desired disposition, thereby acting to diminish the felt weight of the ramp. The springs are then fully tensioned when the ramp is in the desired disposition, ready to assist when the ramp is rotated out of the disposition.

The present invention provides a ramp for use with a flat bed trailer, the ramp pivotally coupled proximate an end margin of the trailer and being shiftable between a loading disposition and a transport disposition, the ramp includes a load support structure. A hinge mechanism is pivotally coupled to the load support structure and the trailer proximate the trailer end margin, the hinge mechanism biasing the load support structure toward an intermediate, neutral disposition. A first hinge pin is fixably coupled proximate the end margin of the trailer and shiftably coupled to the hinge mechanism, the first hinge pin allowing the ramp to be laterally shifted to a multiplicity of positions across the width of the trailer as desired. The present invention is further a hinge mechanism and a trailer.

### BRIEF DESCRIPTION OF THE DRAWINGS

FIG. 1 is a side elevational view of a heavy duty trailer with the spring assist ramp of the present invention disposed in the transport disposition at the rear thereof;

FIG. 2 is a side elevational view of the ramp of the present invention defined in the circle 2 of FIG. 1;

FIG. 3 is a rear elevational view of the left ramp of the present invention disposed in the transport disposition on the rear of the trailer;

FIG. 3a is an enlarged version of FIG. 3;

FIG. 4 is a perspective view of the cantilever bracket of the hinged mechanism of the present invention;

FIG. 5 is a side elevational view of the cantilever bracket of FIG. 4;

FIG. 6 is an end elevational view of the cantilever bracket of FIG. 4;

FIG. 7 is a top elevational view of the ramp;

FIG. 8 is a side sectional view of the ramp taken along the section line 8-8 of FIG. 7; and

FIG. 9 is an enlarged view of the portion of the ramp in circle 9 of FIG. 8.

### DETAILED DESCRIPTION OF THE DRAWINGS

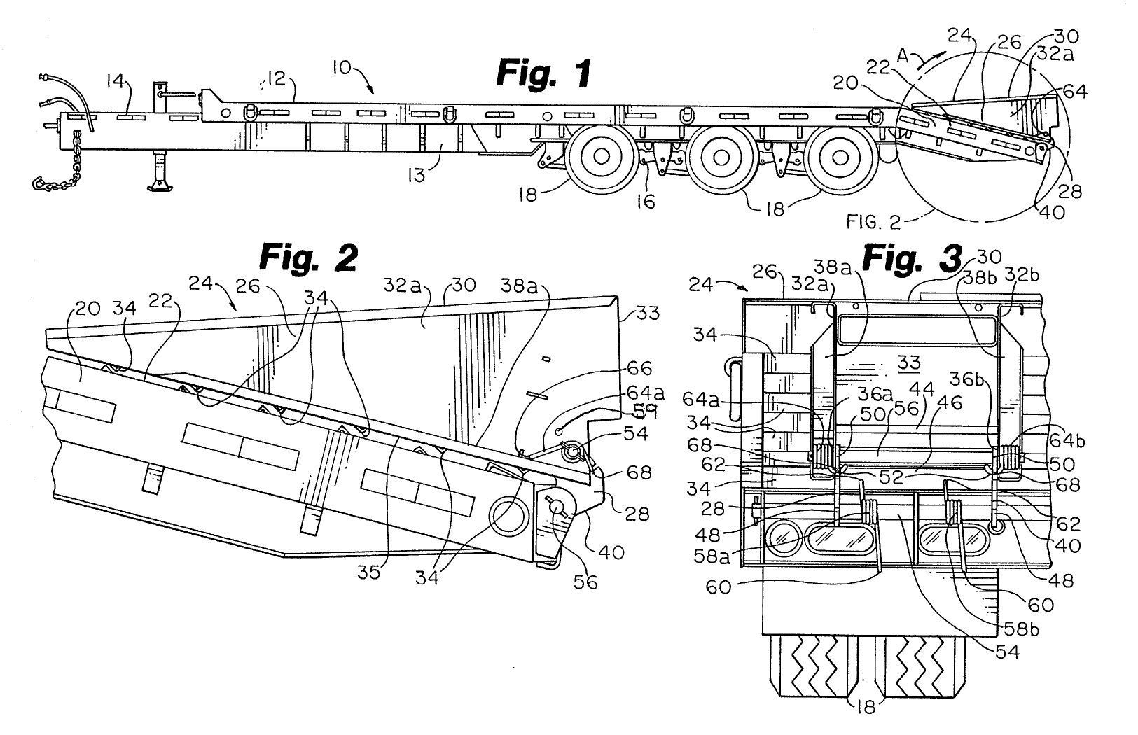

A heavy duty trailer is shown generally at 10 in FIG. 1. The trailer 10 includes a bed 12 supported on a frame 13. Preferably, the frame 13 is formed of two generally parallel, longitudinal rails with a plurality of cross members extending therebetween. The rails of the frame 13 are bent inward at the forward edge of the trailer 10 to define the tongue 14.

The trailer 10 includes a suspension system 16. The suspension system 16 includes a plurality of ground engaging wheels 18.

A declining beaver tail 20 is disposed at the rear of the bed 12. The beaver tail 20 includes a beaver tail bed 22 for supporting a vehicle during the loading and unloading thereof. 20 An exemplary ramp of the present invention is shown generally at 24 in FIGS. 1-3a. The ramp 24 is rotatably hinged at the rear margin of the beaver tail 20. The ramp 24 includes two major components: load support structure 26 and hinge mechanism 28.

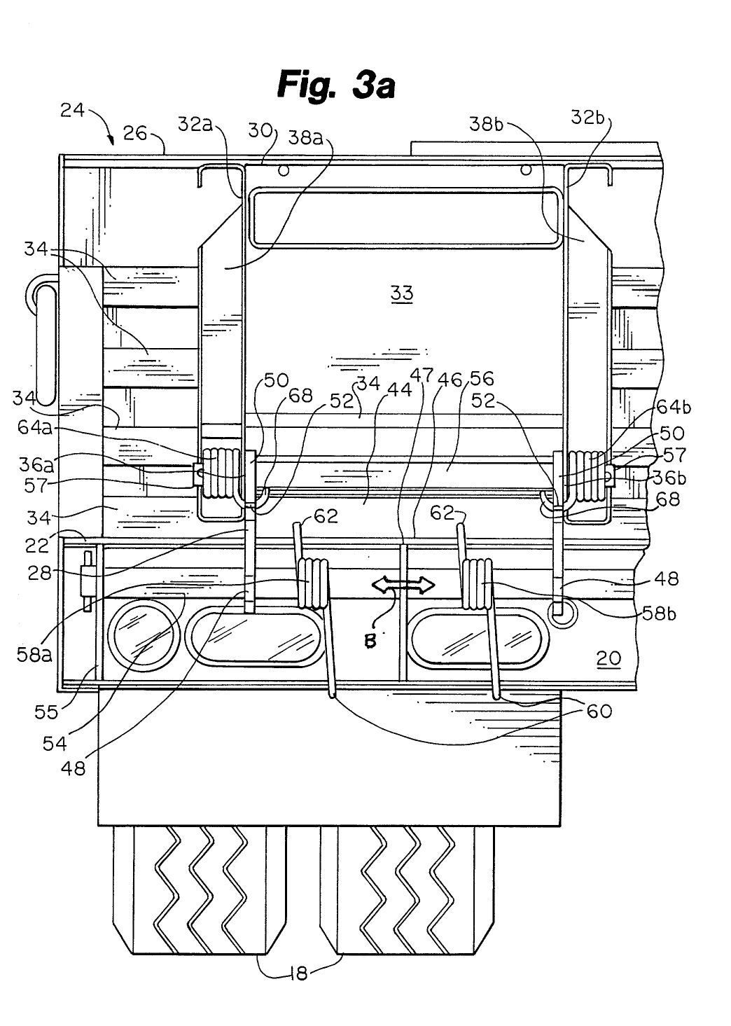

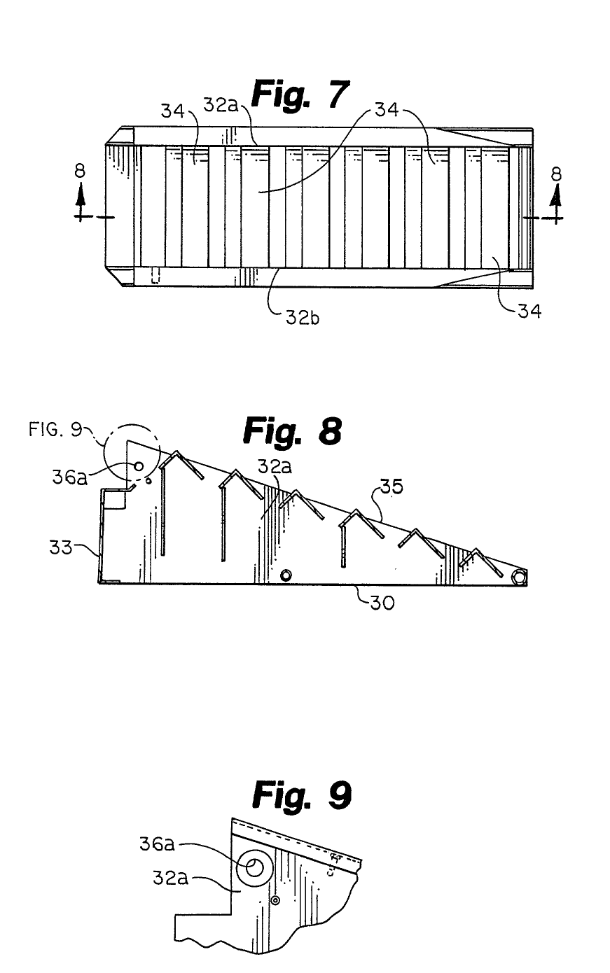

The load support structure 26 of the ramp 24 includes a bottom plate 30 that extends between the bottom margins of two generally parallel spaced apart side plates 32a, 32b. In the transport disposition of the ramp 24, as depicted in FIGS. 1-3a, the bottom plate 30 faces generally upward. When the ramp 24 is disposed in the loading disposition, rotated substantially 180 degrees from the depicted transport disposition, the bottom plate 30 is generally parallel with and in engagement with the ground surface on which the trailer 10 is resting, as depicted in FIG. 8. An end plate 33 (FIG. 3a) extends between end margins of the side plates 32a, 32b and an end margin of bottom plate 30.

Referring to FIGS. 7-9, a plurality of transverse angle irons 34 extend between the two side plates 32a, 32b proximate the upper margin 35 thereof. Each of the side plates 32a, 32b of each of the ramps 24 includes a hinge bore 36a, 36b, respectively defined therein. The two hinge bores 36a, 36b are preferably in registry. The side plates 32a, 32b include a generally outwardly directed lip 38a, 38b, respectively. The lips 38a, 38b extend outwardly from the upper margin 35 of the side plates 32a, 32b.

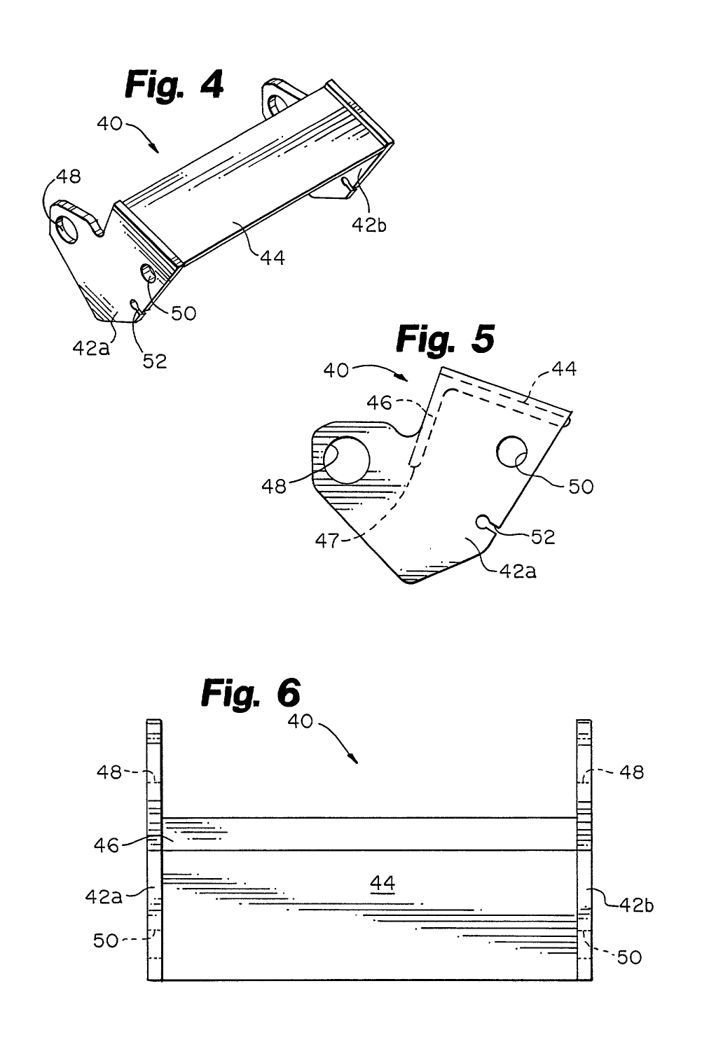

The hinge mechanism 28 of the ramp 24 includes a cantilever bracket such as cantilever bracket 40. The cantilever bracket 40 is best depicted in FIGS. 4-6. The cantilever bracket 40 has two spaced apart, generally parallel side plates 42a, 42b. A top plate 44 extends between the two side plates 42a, 42b. The cantilever bracket 40 is strengthened by a gusset 46 that depends from top plate 44. Together, the top plate 44 and the gusset 46 are generally transverse to one another in cross section and are integrally formed. The gusset 46 has a lower margin 47.

There are two hinge bores defined in each of the side plates 42a, 42b. The first such hinge bore is bed hinge bore 48. The second hinge bore preferably has a slightly smaller diameter than the bed hinge bore 48 and is the ramp hinge bore 50. At least one spring retainer groove 52 is defined in an edge margin of the cantilever bracket 40.

The cantilever bracket 40 is hinged at a first point at the rear margin of the beaver tail 20, proximate the beaver tail bed 22. This hinging is accomplished by a bed hinge pin 54 that preferably extends substantially the full width of the rear margin of the beaver tail 20 or a pair of adjacent bed hinge pins 54, each bed hinge pin 54 supporting a respective ramp 24. Each hinge pin 54 has a greater length than the width of the respective ramp 24 to accommodate lateral shifting of the ramp 24 as desired to support vehicles of varying track widths. Preferably the cantilever bracket 40 of both of the two ramps 24 is hingably engaged with the bed hinge pin 54. As depicted in FIG. 3a, the bed hinge pin 54 is borne in bracket 55, the bracket 55 extending rearward from the rear margin of the beaver tail 20. The bed hinge pin 54 passes through the bed hinge pin bores 48 of the side plates 42a, 42b.

A second hinge point of the cantilever bracket 40 hinges the cantilever bracket 40 to the load support structure 26 of the ramp 24. The hinge bores 36a, 36b defined in the side plates 32a, 32b, respectively, are brought into registry with the ramp hinge bores 50 defined in the side plates 42a, 42b, respectively, of the cantilever bracket 40. A ramp hinge pin 56 is passed successively through the hinge bore 36a, the two ramp hinge bores 50, and the hinge bore 36b. The two ends 57 of the ramp hinge pin 56 project outwardly beyond the side plates 32a, 32b of the load support structure 26. As depicted in FIG. 2, a removable lock pin (not shown) may be inserted in bore 59 to keep the ramp 24 from bouncing when being transported in the transport disposition.

Biasing of each of the ramps 24 is effected by two sets of biasing springs. The first such set includes one or more biasing members such as first biasing springs 58a, 58b. The first biasing springs 58a, 58b are coiled around the bed hinge pin 54. A first end 60 of each of the first biasing springs 58a, 58b bears on the rear margin of the beaver tail 20. The second end 62 of the first biasing springs 58a, 58b hooks around the lower margin 47 of the gusset 46 and bears on the top plate 44. First biasing springs 58a, 58b typically exert the greatest bias on the ramps 24 of the two sets of biasing springs and are tensioned when the ramp 24 is in the loading disposition. Biasing springs 58a, 58b are unloaded in the neutral disposition.

The second such set of biasing springs includes one or more biasing members such as second biasing springs 64a, 64b. The second biasing springs 64a, 64b are coiled around the respective pin ends 57 of the ramp hinge pin 56 and act opposite to the first biasing springs 58a, 58b. A first end 66 of each of the second biasing springs 64a, 64b bears on the respective lips 38a, 38b of the side plates 32a, 32b. The second end 68 of each of the second biasing springs 64a, 64b is curled through the spring retainer groove 52 of the respective side plates 42a, 42b of the cantilever bracket 40. Biasing springs 64a, 64b are tensioned in the transport disposition and unloaded in the neutral disposition.

In operation, the ramp 24 is shifted from the transport disposition to the loading disposition by rotating the ramp 24 about the hinge mechanism 28 as indicated by arrow A of FIG. 1. Such rotation is through an arc of substantially 180 degrees. In the transport disposition, the first biasing springs 58a, 58b are substantially untensioned and the second biasing springs 64a, 64b are tensioned such that the second biasing springs 64a, 64b exert a biasing force urging the ramp 24 toward a substantially vertical neutral disposition. In the loading disposition, the first biasing springs 58a, 58b are fully tensioned and the second biasing springs 64a, 64b are substantially untensioned such that the first biasing springs 58a, 58b exert a substantial amount of biasing force tending to urge the ramp 24 toward the substantially vertical neutral disposition. In the neutral disposition, first biasing springs 58a, 58b and second biasing springs 64a, 64b apply no tension on the ramp 24. The user must exert a minimum of force to the ramp 24 such that the ramp 24 continues to rotate in either direction beyond the neutral disposition. Once out of the neutral disposition, the weight of the ramp 24 is enough to tension either the first biasing springs 58a, 58b or second biasing springs 64a, 64b as a function of whether the ramp is rotated to the load disposition (tensioning springs 58a, 58b) or to the transport disposition (tensioning springs 64a, 64b). Regardless of whether the ramp 24 is located in the loading or the transport disposition, either the first biasing springs 58a, 58b and second biasing springs 64a, 64b assist the user in accomplishing rotation from one disposition to another. Increasing the strength or number of biasing springs could be utilized as desired to provide additional force in favor of the neutral disposition.

Rotating the ramp 24 as indicated by the arrow A in FIG. 1 decreases the tension in the second biasing springs 64a, 64b, such that when the ramp 24 is in the neutral disposition, the second biasing springs 64a, 64b are no longer biased. In the neutral disposition, first biasing springs 58a, 58b are unbiased and fully unwound. At this point, ramp 24 can be slidably adjusted across the width of trailer 10 by sliding ramp 24 laterally along bed hinge pin 54 to adjust the distance between the two ramps 24 as desired as indicated by arrow B of FIG. 3a. When the ramp 24 is in the desired location, the user exerts force on the ramp 24 so as to place the ramp 24 in the loading disposition. As the ramp 24 rotates to the loading disposition, the first biasing springs 58a, 58b are tensioned around bed hinge pin 54. Tensioning the first biasing springs 58a, 58b serves to lock the ramp 24 into position by preventing further slidable adjustment along the bed hinge pin 54. When in the loading disposition, the springs 58a, 58b are fully tensioned (springs 64a, 64b being untensioned) and ready to assist the user in raising the rap 24 (motion opposite to the arrow A of FIG. 1).

In summary, springs 64a, 64b assist the user to rotate the ramp 24 from the transport disposition to the vertical neutral disposition as indicated by arrow A. Springs 58a, 58b assist the user to rotate the ramp 24 from the loading disposition to the vertical neutral disposition counter to arrow A.

While the preferred embodiment of the present invention has been illustrated and described herein, it is to be understood that the invention is not limited to the precise construction so illustrated and described. Accordingly, it is intended that the scope of the present invention be dictated by the scope of the appended claims and not by the description of the preferred embodiment.

What is claimed is:

1. A hinge mechanism for pivotally coupling a ramp to a flat bed trailer, the ramp being shiftable between a transport disposition and a loading disposition, comprising:
a cantilever bracket hingably coupling the ramp and the trailer;
at least a first biasing member and a second biasing member cooperating with the cantilever bracket to bias the ramp toward an intermediate, neutral disposition; and
a first hinge pin fixably coupled proximate a margin of the trailer and shiftably supporting the cantilever bracket for accommodating lateral shifting of the cantilever bracket relative to the trailer to set a desired track width.

2. The hinge mechanism of claim 1, the cantilever bracket comprising first, second, third, and fourth bracket members, the second, third, and fourth bracket members depending from the first bracket member, the second and third bracket members defining first and second pluralities of bores, the first plurality of bores for connecting the cantilever bracket to the trailer and the second plurality of bores for connecting the cantilever bracket to the first hinge pin.

3. The hinge mechanism of claim 1, the cantilever bracket defining first and second pluralities of bores for pivotally connecting the cantilever bracket to the first hinge pin and to the ramp and a retainer configured for biasing contact with the second biasing member.

4. The hinge mechanism of claim 3, the cantilever bracket comprising a top bracket member and first, second, and third side bracket members extending generally transversely from the top bracket member, each first and second bracket side member defining one of each said first and second pluralities of bores.

5. The hinge mechanism of claim 1, in which the first biasing member includes first and second ends and is disposed about the first hinge pin, the first biasing member first end bearing on the trailer and the first biasing member second end bearing on a supporting bracket.

6. The hinge mechanism of claim 5, the second biasing member including first and second ends, the second biasing member disposed about a second hinge pin, the second hinge pin pivotally connecting the cantilever bracket to the ramp, the second biasing member first end biased against the cantilever bracket retainer and the second biasing member second end biased against the ramp.

7. The hinge mechanism of claim 1, wherein a force exerted by the biasing members is increased during shifting of the ramp from the intermediate, neutral disposition.

8. The hinge mechanism of claim 7, wherein the biasing members exert a force countering between substantially 25 percent to 75 percent of the weight of the ramp when the ramp is shifted toward the intermediate, neutral disposition.

9. A ramp for use with a flat bed trailer, the ramp pivotally coupled proximate an end margin of the trailer and being shiftable between a loading disposition and a transport disposition, the ramp comprising:
a load support structure;
a hinge mechanism pivotally coupled to the load support structure and the trailer proximate the trailer end margin, the hinge mechanism biasing the load support structure toward an intermediate, neutral disposition; and
a first hinge pin fixably coupled proximate the end margin of the trailer and shiftably coupled to the hinge mechanism, the first hinge pin allowing the ramp to be laterally shifted to a multiplicity of positions across the width of the trailer as desired.

10. The ramp of claim 9, the hinge mechanism including a cantilever bracket, a first spring, and a second spring, the cantilever bracket pivotally connecting the load support structure and the trailer, the first spring and second spring biasing the cantilever bracket relative to the trailer.

11. The ramp of claim 10, the cantilever bracket including a top plate, a plurality of side plates and a gusset, the side plates and the gusset extending from the top plate, the first spring disposed about a first hinge pin and biasing the load support structure in a first direction relative to the trailer, the second spring disposed about a second hinge pin and biasing the load support structure in a second opposed direction relative to the trailer.

12. The ramp of claim 9, wherein a force exerted by the hinge mechanism is increased during shifting of the ramp from the intermediate, neural disposition.

13. The ramp of claim 12, wherein the hinge mechanism exerts a force countering between substantially 25 percent and 75 percent of the weight of the ramp when the ramp is shifted from the intermediate, neutral disposition.

14. A ramp for use with a flat bed trailer, the ramp pivotally coupled to the trailer and being both shiftable between a loading disposition and a transport disposition as well as laterally shiftable relative to a rear margin of the trailer, the ramp comprising:
a load support structure;
a hinge mechanism having:
a cantilever bracket including two side plates and each side plate defining a first and a second bore, the cantilever bracket being pivotally coupled to the ramp and to the trailer, and
first and second springs, the first spring biasing the load support structure from the transport disposition toward an intermediate neutral disposition, and the second spring biasing the load support structure from the loading disposition toward the intermediate neutral disposition; and
the first hinge pin being fixably coupled to the rear margin of the trailer, the cantilever bracket being selectively laterally shiftable relative to the first hinge pin when the ramp is in the intermediate, neutral disposition.

15. The ramp of claim 14, wherein a force exerted by the hinge mechanism is increased during shifting of the ramp from the intermediate neutral disposition.

16. The ramp of claim 15, wherein the hinge mechanism exerts a force countering between substantially 25 percent and 5 percent of the weight of the ramp when the ramp is shifted from the intermediate, neutral disposition.

17. A trailer, comprising:
a substantially flat bed; and
a ramp having;
a load support structure,
a hinge mechanism having;
a cantilever bracket pivotally coupled to the ramp and the trailer, and
at least two springs, the first spring biasing the load support structure from a transport disposition toward an intermediate neutral disposition and the second spring biasing the load support structure from a loading disposition toward the intermediate neutral disposition.

18. The trailer of claim 17, wherein the hinge mechanism is both rotatably shiftable for shifting of the ramp between the transport disposition and the loading disposition as well as laterally shiftable relative to the flat bed of the trailer.

19. The trailer of claim 18, wherein the respective first and second springs exert a force countering between substantially 25 percent and 75 percent of the weight of the ramp when the ramp is shifted from the intermediate, neutral disposition.
